(19) United States
(12) Patent Application Publication
(10) Pub. No.: US 2025/0131366 A1
(43) Pub. Date: Apr. 24, 2025

(54) GENERATING ACTIONS FOR A SUPPLY CHAIN NETWORK

(71) Applicant: X Development LLC, Mountain View, CA (US)

(72) Inventors: Lam Thanh Nguyen, Santa Clara, CA (US); Grace Taixi Brentano, San Francisco, CA (US); Sze Man Lee, Mountain View, CA (US); Karush Suri, Mountain View, CA (US); Anikait Singh, Fremont, CA (US); Salil Vijaykumar Pradhan, San Jose, CA (US); David Andre, San Francisco, CA (US); Gearoid Murphy, Mountain View, CA (US)

(21) Appl. No.: 18/926,132

(22) Filed: Oct. 24, 2024

Related U.S. Application Data
(60) Provisional application No. 63/545,528, filed on Oct. 24, 2023.

(51) Int. Cl. G06Q 10/08

(52) U.S. Cl. CPC G06Q 10/08

(57) ABSTRACT

Methods, systems, and apparatus, including computer programs encoded on computer storage media, for generating actions for a supply chain network. One of the methods includes receiving a request to generate an action in a supply chain network for a particular product based on current state information; providing a request to an action model to generate a respective probability distribution for one or more actions for one or more products; receiving, from the action model, the respective probability distributions for the one or more products; determining, for each product, a binned action from the respective probability distribution; providing a request to a sequence model to generate a respective correction for the one or more binned actions; and receiving, from the sequence model, the respective correction for the respective binned action.

### CROSS-REFERENCE TO RELATED APPLICATION

This application claims priority to U.S. Provisional Application No. 63/545,528, filed on Oct. 24, 2023. The disclosure of the prior application is considered part of and is incorporated by reference in the disclosure of this application.

### BACKGROUND

This specification relates to generating actions for a supply chain network.

A supply chain network can include many entities that are involved in the production and transport of objects. For example, a supply chain network can include a supplier of textiles that sends a truck to transport textiles from a shipping port to a factory, and another truck that transports toys made in the factory with the textiles to a retailer.

Supply chain networks often face disruptions, for example, because the entities in the supply chain are unable to efficiently process data having a huge action space, e.g., many different kinds of products. For example, an entity in the supply chain may have to make decisions such as whether to order a product, when to order a product, or how many products to order, for tens, hundreds, or thousands of products. These inefficiencies can have severe or even catastrophic real-world consequences.

### SUMMARY

This specification describes how a system can generate actions that can be taken by entities in a supply chain network that includes a large number of objects or products. For example, the system can receive information representing a current state of an environment of the supply chain network. The system can generate binned actions for each product that compress the action space of actions that need to be considered by entities making supply chain network decisions. Closely related actions can be represented by the same binned action. For example, ordering 10 medium blue shirts and 11 medium blue shirts can be represented by a single binned action rather than two separate actions.

Particular embodiments of the subject matter described in this specification can be implemented so as to realize one or more of the following advantages.

The techniques described in this specification can be scaled to apply to large numbers of objects or products, and thus allow supply chain entities to efficiently generate actions where the complexity of each action is very high. For example, an action for a product can include how many units of the product to order, and when to place an order for the product. Each product can differ from other products in size, color, pattern, design, shape, etc. For supply chain networks that involve a large number of products transported between entities of the supply chain network, it may be computationally expensive and time intensive to make decisions for every product because of the size of the action space.

The techniques described in this specification can allow supply chain entities to efficiently generate actions while selecting an action for each product. For example, the techniques include receiving a request to generate an action in a supply chain network for a particular product based on information representing a current state of the environment. One technique can solve the large action space through multi-task reinforcement learning. For example, the technique includes obtaining a probability distribution for different actions for multiple products from a model based on information representing the current state of the environment. The technique includes determining a binned action for each product. A binned action includes one or more related actions. For example, a binned action may include the action of ordering five of a particular product, and the action of ordering six of a particular product. The technique can further refine each binned action for each product by generating a correction for each binned action using a language model.

Examples of binned actions include ordering a certain number of units of a product, the instructions to manufacture a certain product, or a prioritization of the delivery of a certain product.

The techniques described in this specification can also allow for representing how actions for one product can affect the actions generated for another product, capturing possible dependencies or relationships between products. For example, the techniques include obtaining a representation of the current state of the environment, determining a representation for each product, and obtaining a binned action for each product from a model based on the representation for each product. The model can generate binned actions conditioned on previously generated binned actions for other products. That is, the model can incorporate information from previously generated binned actions.

The techniques described in this specification can also allow supply chain entities to efficiently generate actions by increasing the number of agents used to generate actions. For example, the techniques include clustering multiple products, and generating a binned action for each product in each cluster using an agent assigned to each cluster. Each agent can generate a binned action for each product in each cluster using any of a variety of techniques for generating actions. Each agent can have its own action space that includes a subset of the actions for all of the products, and each agent can generate actions for a subset of the products, thus dividing the computational time and load over multiple agents. Because each agent generates actions for a particular set of products in its assigned cluster, each agent can be a high-performing domain-specific agent. Each agent can handle changes in demand patterns quickly and efficiently because the agents generate actions for a subset of products. In addition, the techniques do not require modifying the reward function or action space reduction strategies for each agent, thus allowing the agents to be trained faster.

The techniques described in this specification can allow supply chain entities to quickly generate actions and thus select actions to be performed based on the current state of the environment of the supply chain, which can result in: a reduction in “idle time” of carrier or shipper assets, increased profitability, a lower carbon footprint realized through more effective shipping asset utilization, a reduction in warehouse or network backups, reduced road or supply network congestion, supply chain shortage prevention, increased confidence in substantial or expensive business decisions, and an increased ability to respond to world events. In addition, the techniques can lead to reductions in processing requirements driven by increased decision making ability, and the ability to generate actions for each product.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system for generating actions for a supply chain network.

FIG. 2 is a diagram of an example model for generating probability distributions for actions.

FIG. 3 is a flowchart of a process for generating actions for a supply chain network.

FIG. 4 is a diagram of another example system for generating actions for a supply chain network.

FIG. 5 is a flowchart of another process for generating actions for a supply chain network.

FIG. 6 is a diagram of another example system for generating actions for a supply chain network.

FIG. 7 is a flowchart of another process for generating actions for a supply chain network.

Like reference numbers and designations in the various drawings indicate like elements.

### DETAILED DESCRIPTION

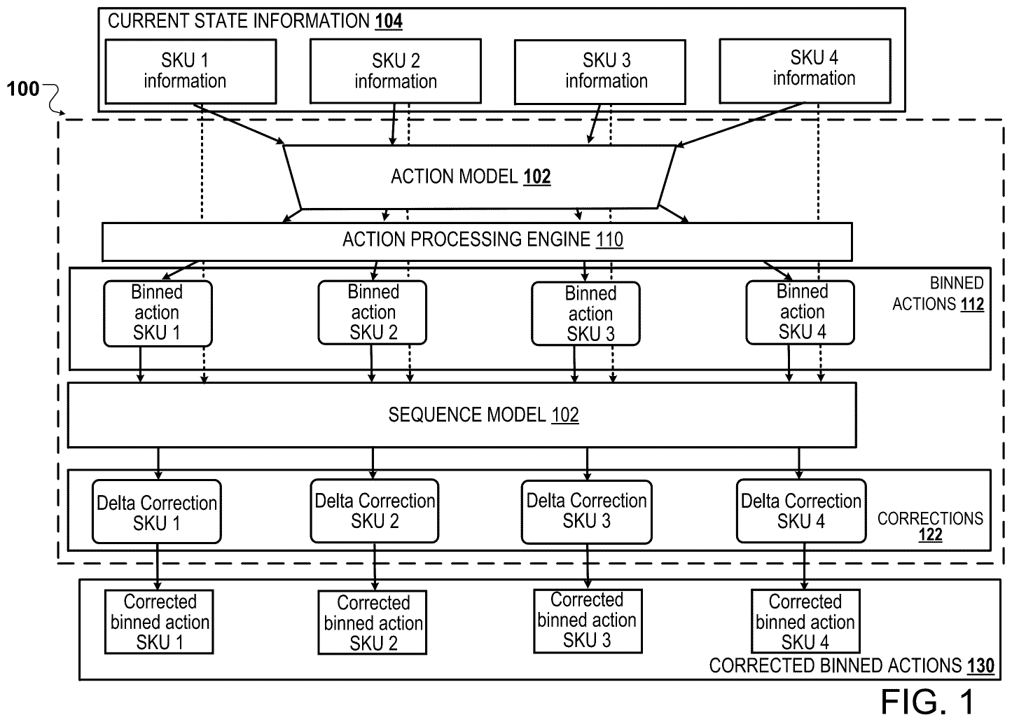

FIG. 1 is a diagram of an example system 100 for generating actions for a supply chain network. The system 100 is an example of a system implemented as computer programs on one or more computers in one or more locations in which the systems, components, and techniques described below are implemented.

The system 100 includes various components, such as an action model 102, an action processing engine 110, and a sequence model 120. In some implementations, the action model 102, the action processing engine 110, and the sequence model 120 can be part of a same system and/or network of computing devices and/or systems.

The system 100 can allow a supply chain entity to generate an action for one or more products of the supply chain network. The system 100 can receive information about the supply chain network, including information about the products of the supply chain network, and generate a binned action for a particular product using the action model 102 and the sequence model 120 as described below.

The system 100 can receive current state information 104. The current state information 104 can include information representing a current state of an environment. The environment can include the products of the supply chain network and the entities of the supply chain network. Information representing the current state of the environment can include a state of the supply chain network, such as weather conditions near entities of the supply chain network, weather conditions along transportation routes of the supply chain network, natural disasters, or a manufacturing capacity of an entity.

Information representing the current state of the environment can also include information about the products of the supply chain network, such as inventory levels, shipment data, forecasted demand, or lead time for each product. Information about the products of the supply chain network can also include features of each product, such as shape, size, or color. Information representing the current state of the environment can also include past information about products such as history of orders, history of inventory levels, or history of shipment data. In FIG. 1, for example, the current state information 104 includes information for products referred to as “SKU 1,” “SKU 2,” “SKU 3,” and “SKU 4.”

Alternatively or in addition, the system 100 can receive the current state information 104 from a simulator. For example, the simulator can simulate the occurrence of environmental conditions such as weather, or the occurrence of actions performed for one or more products such as ordering a certain number of a particular product. The simulator can generate information representing the current state of the environment based on the simulations. Examples of techniques for simulating supply chain networks, obtaining information representing a current state of an environment, and generating binned actions are described in commonly owned U.S. Patent Application No. 63/487,237, filed on Feb. 27, 2023, which is herein incorporated by reference.

The system 100 can provide the current state information 104 to the action model 102. The action model 102 can be configured to generate a probability distribution for one or more actions for each product in the current state information 104. The probability distribution for each product can represent a predicted probability for performing an action given the current state of the environment. For example, the probability distribution can represent the probability of ordering a particular number of products for a given state.

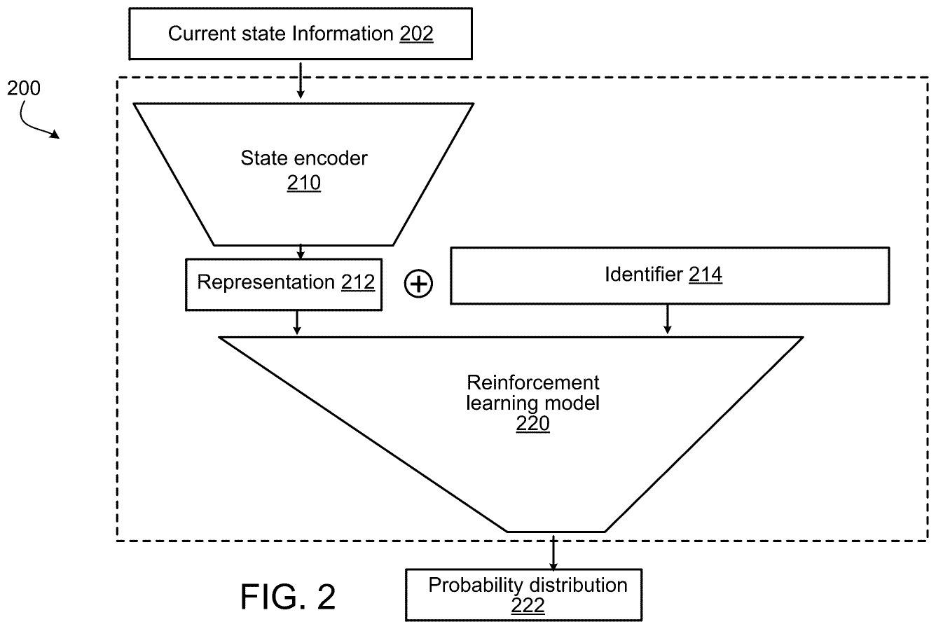

The action model 102 can be configured to generate a probability distribution for each product by first generating a representation of the current state information 104, and then providing the representation of the current state information 104 and an identifier for a particular product to a machine learning model configured to generate a probability distribution for the particular product of the identifier. An example of an action model that the system 100 can use as the action model 102 is described in further detail below with reference to FIG. 2. For example, as described below, the action model 102 can include one or more machine learning models such as a state encoder and/or a reinforcement learning model.

The action processing engine 110 can be configured to determine binned actions 112 from the probability distributions. The action processing engine 110 can receive a probability distribution for one or more actions for each product from the action model 102. For example, for a particular probability distribution, the action processing engine 110 can combine related actions of the probability distribution into binned actions. For example, the action processing engine 110 can add the probabilities for the actions of buying 11 units of the product and buying units of the product. The action processing engine 110 can determine a binned action for the product by selecting the binned action with the highest combined probability. In FIG. 1, for example, the binned actions 112 include “binned action SKU 1,” “binned action SKU 2,” “binned action SKU 3,” and “binned action SKU 4.”

As another example, for a particular probability distribution, the action processing engine 110 can categorically sample the binned action from the particular probability distribution. For example, the action processing engine 110 can determine the binned action to be the action that is most often sampled out of a sample from the probability distribution.

The system 100 can provide the binned actions 112 to the sequence model 120. The sequence model 120 can be configured to generate corrections 122 for the binned actions 112 given the binned actions 112 and the current state information 104. The corrections 122 for the binned actions 112 can account for the uncertainty of the probability distributions generated by the sequence model 120, for example, and provide for a more refined prediction for the action for each product. The corrections 122 can also lead to higher accuracy and account for cross-product constraints. In FIG. 1, for example, the corrections 122 include “delta correction SKU 1,” “delta correction SKU 2,” “delta correction SKU 3,” and “delta correction SKU 4.” An example correction can include, for example, data representing a certain number of units less than indicated in the corresponding binned action, or a certain number of units more than indicated in the corresponding binned action.

The sequence model 120 can include a seq2seq model that has been trained to generate a sequence of corrections for binned actions given a sequence of binned actions. For example, the seq2seq model can be a large language model. In this context, a large language model is a machine learned subsystem that uses one or more transformer layers that autoregressively transform an input sequence using self-attention. The transformer architecture is described in Vaswani et al., Attention Is All You Need, in the proceedings of the 31st Conference on Neural Information Processing Systems (2017).

A large language model described in this specification can be implemented using encoders, decoders, or some combination of these. In this specification, an encoder is a language model having one or more transformer layers that takes an input sequence of tokens representing text and generates one or more output representations of the input sequence that can be used for a number of downstream tasks. In this specification, a decoder is a language model having one or more transformer layers that generates one or more output tokens for a sequence of input tokens. In practice, the input sequence can include learned word embeddings, e.g., vector representations to represent each word in a text input sequence. In the example of FIG. 1, the input sequence can include the sequence of binned actions.

In some implementations, the sequence model 120 can also be configured to perform meta-optimization techniques such as model-agnostic meta-learning. For example, the sequence model 120 can be configured to determine a shared parameter across all products, and then optimize the parameters for each product independently. Using meta-learning techniques can enable the system 100 to take advantage of general optimization behaviors, such as if the warehouse inventory for a product is low, to order more of the product. Meta-learning can also allow for the efficient addition or removal of products.

The system 100 can then apply the corrections 122 to the corresponding binned actions 112 to generate corrected binned actions 130. For example, the system 100 can apply “delta correction SKU 4” to “binned action SKU 4” to generate “corrected binned action SKU 4.” The system 100 can provide the corrected binned action for each product to a supply chain entity.

The supply chain entity may implement one or more of the corrected binned actions 130. In some implementations, the supply chain entity can select to take one or more of the corrected binned actions 130, and the system 100 can provide information representing the taken corrected binned actions to the simulator. The system 100 can then receive new current state information 104 from the simulator, and generate new corrected binned actions based on the new current state information 104.

FIG. 2 is a diagram of an example action model 200 for generating probability distributions for actions. The action model 200 can be an example of the action model 102 described above with reference to FIG. 1. The action model 200 can include a state encoder 210 and a reinforcement learning model 220.

The action model 200 can receive current state information 202 representing the current state of the environment. For example, the current state information 202 can include at least a subset of the current state information 104 described above with reference to FIG. 1. In some implementations, the system 100 may aggregate the subset of the current state information 104 that corresponds to a particular entity's products. For example, the current state information 202 may include information about the products for a particular entity of the supply chain network. Information about the products can include inventory levels, shipment data, forecasted demand, and past information such as history of orders, history of inventory levels, or history of shipment data. Information about the products can also include features of each product, such as shape, size, or color.

The state encoder 210 can be a model such as a machine learning model that has been trained to generate a representation 212 of a current state of an environment given information representing the current state of the environment. The state encoder model 210 can be a Transformer model, for example.

The representation 212 of the current state of the environment can be a sequence of representations of products, where each representation in the sequence represents each product of the current state information 202.

Each representation for a product can represent information from the current state information 104 that is relevant to the product. For example, each representation for a product can include an embedding for features of the product. For example, features of a particular product can include color, shape, or size.

The model 200 can provide the representation 212 to the reinforcement model 220. The model 200 can also provide an identifier 214 to the reinforcement model 220. The identifier 214 can be a vector that identifies a particular product that the representation 212 includes a representation for. For example, the vector can include a “1” at the index corresponding to the particular product, and a “0” at every other index. The index corresponding to the particular product can correspond to the index of the representation for the particular product in the sequence of the representation 212.

The reinforcement learning model 220 can be trained to generate a probability distribution 222 for one or more actions for a particular product given the representation 212 of the current state of the environment and the identifier 214 for the particular product. For example, the identifier 214 may identify a product, SKU 1. The reinforcement learning model 220 can thus generate a probability distribution 222 for the product SKU 1.

The reinforcement learning model 220 can be trained to generate probability distributions for actions for a particular product, where the actions are selected to optimize for a reward for an aggregate action. The aggregate action can include a list of actions for all of the products of the current state information 202. For example, the reinforcement learning model 220 can perform the most probable actions, which modifies the supply chain and the current state of the environment, and collect rewards based on values of a performance metric for the supply chain. For example, a performance metric can measure cost, time, or emissions.

In some implementations, the reinforcement learning model 220 can be trained to generate a probability distribution 222 for all possible actions that can be performed over all of the products in the environment. In some implementations, the reinforcement learning model 220 can be trained to generate a probability distribution 222 for a subset of all possible actions that can be performed over all of the products in the environment.

The probability distribution 222 for the particular product can represent, for one or more actions, a predicted probability for performing the action given the current state represented in the representation 212. For example, the probability distribution 222 can represent the probability of ordering the product SKU 1 under the optimal policy, or the probability of ordering a certain number of units of the product SKU 1 under the optimal policy.

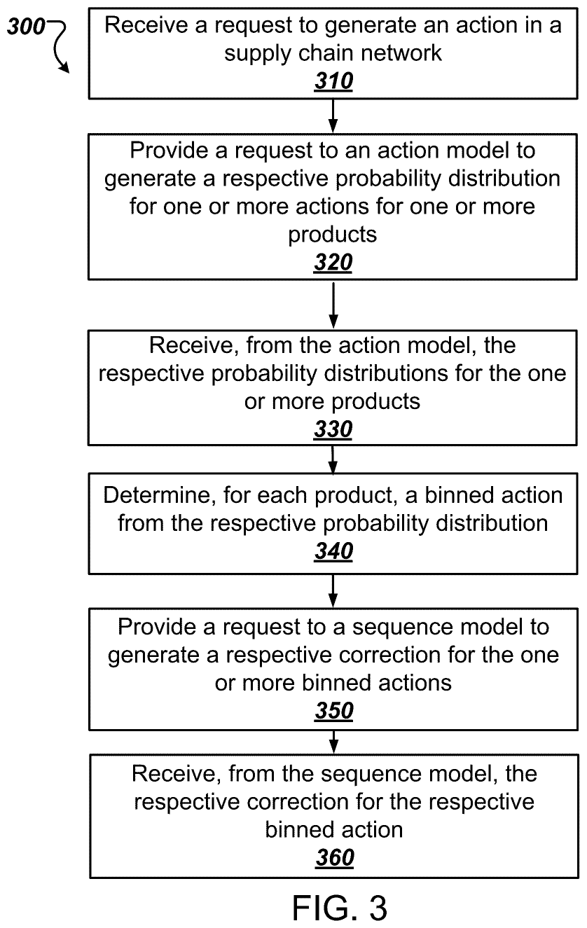

FIG. 3 is a flowchart of a process 300 for generating actions for a supply chain network. The process 300 can be performed by any appropriate system of one or more computers in one or more locations, e.g., the system 100 of FIG. 1.

The system receives a request to generate an action in a supply chain network (310). The system can generate an action in a supply chain network for a particular product based on current state information representing a current state of an environment. The environment can include one or more products, including the particular product. Current state information representing a current state of an environment can include, for example, a state of the supply chain network, inventory levels for the one or more products, and shipment data for the one or more products.

The system provides a request to an action model to generate a respective probability distribution for one or more actions for the one or more products (320). The request can include information representing the current state of the environment. For example, the action model can be configured to generate probability distributions for actions that can be performed for products given information about the environment of the products.

The system receives, from the action model, the respective probability distributions for the one or more products (330). The probability distribution for each product can represent a predicted probability for performing an action given the state of the environment.

In some implementations, the action model can include a state encoder that generates a representation of the current state of the environment given current state information. The representation of the current state of the environment can include a representation for each product. For example, the representation of the current state of the environment can include an embedding for features of each of the one or more products. For example, the features can include color, shape, and/or size. The action model can also include a trained reinforcement learning model that generates a probability distribution for one or more actions for the particular product given a representation of the current state of the environment and an identifier for the particular product.

The system determines, for each product, a binned action from the respective probability distribution (340). Each binned action can include one or more related actions.

The system provides a request to a sequence model to generate a respective correction for the one or more binned actions (350). The request can include an input based on the respective binned action for the one or more products. For example, the sequence model can be configured to generate corrections for the binned actions given the binned actions and the current state information.

The system receives, from the sequence model, the respective correction for the respective binned action (360). Each correction can represent a change to the binned action. The system can also apply, for each binned action, the respective correction for the binned action. For example, for each binned action, the system can add the change represented by the correction to the binned action to generate a corrected binned action.

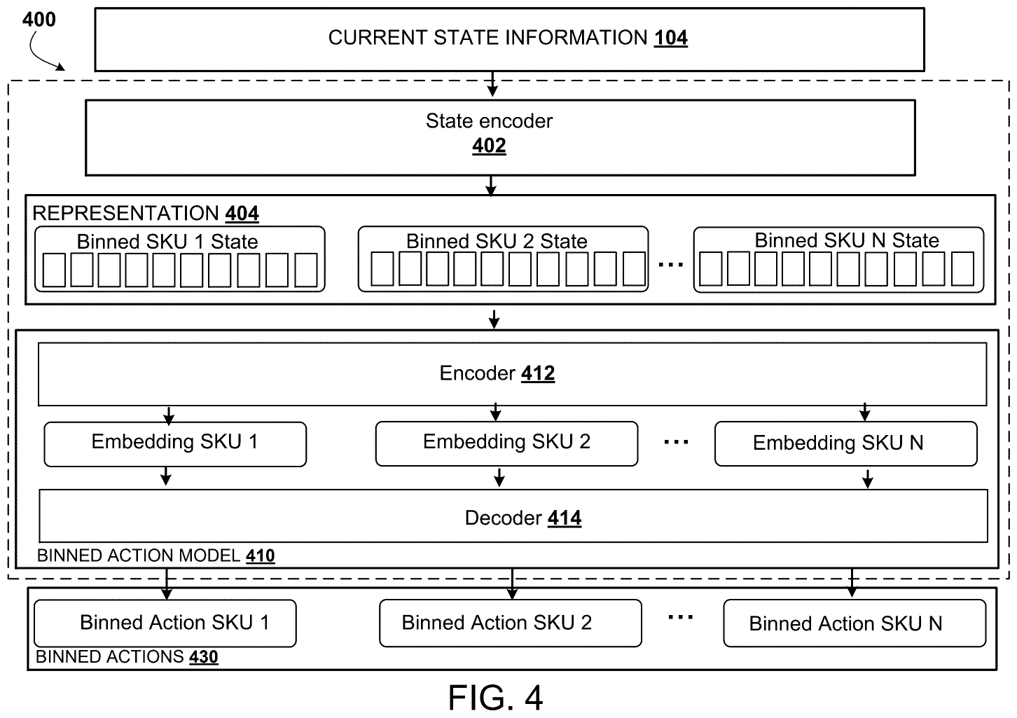

FIG. 4 is a diagram of another example system 400 for generating actions for a supply chain network. The system 400 is an example of a system implemented as computer programs on one or more computers in one or more locations in which the systems, components, and techniques described below are implemented.

The system 400 includes various components, such as a state encoder 402 and a binned action model 410. The binned action model 410 can include an encoder 412 and a decoder 414. In some implementations, the state encoder 402 and the binned action model 410 can be part of a same system and/or network of computing devices and/or systems.

The system 400 is similar to the system 100 described above in that the system 400 can allow a supply chain entity to generate an action for one or more products of the supply chain network. The system 100 can receive information about the supply chain network, including information about the products of the supply chain network, and generate a binned action for a particular product using the state encoder 402 and the binned action model 410 as described below.

The system 400 can receive current state information 104. The current state information 104 can include information representing a current state of an environment. The current state information 104 is described in more detail above with reference to FIG. 1.

The system 400 can provide the current state information 104 to the state encoder 402. The state encoder 402 can be similar to the state encoder 210 described above with reference to FIG. 2 in that the state encoder 402 is configured to generate a representation 404 of the current state of the environment given the current state information 104.

The representation 404 of the current state of the environment can be a sequence of product representations, where each product representation in the sequence represents a product of the current state information 202. The representation 404 of FIG. 4 shows product representations “Binned SKU 1 State,” “Binned SKU 2 State,” “Binned SKU N State,” corresponding to products SKU 1, SKU 2, SKU N.

Each product representation for a product can represent information from the current state information 104 that is relevant to the product. For example, each product representation for a product can include an embedding for features of the product. For example, features of a particular product can include color, shape, or size.

The system 400 can determine a product representation for each product in the representation 404. For example, the system 400 can determine that the product representation for a product is at a corresponding index in the sequence of representation 404. The system 400 can maintain a mapping of information about a product in current state information 104 to the index of the product representation in the representation 404 using an identifier for each product, for example.

The system 400 can provide the representation 404 to the binned action model 410. The binned action model 410 can be a machine learning model that is configured to generate a binned action for each product given a product representation for each product. For example, the binned action model 410 can be an autoregressive model. In some implementations, the binned action model 410 can be an attention-based model. In some implementations, the binned action model 410 can be a diffusion model.

In the example of FIG. 4, the binned action model 410 is an autoregressive attention-based Transformer model. For example, the binned action model 410 can be a self-attention based model. The binned action model 410 can be configured to generate each binned action for a product based on the product representation for the product and the binned actions that the binned action model 410 generated for previous products.

In some implementations, the binned action model 410 can be trained to generate a binned action that is one of all possible binned actions that can be performed over all of the products in the environment. In some implementations, the binned action model 410 can be trained to generate a binned action for a subset of all possible binned actions that can be performed over all of the products in the environment.

The binned action model 410 can include an encoder 412 and a decoder 414. The encoder 412 can be configured to generate an embedding for each product given the product representation for the product. For example, the encoder 412 can generate “embedding SKU 1” for the “binned SKU 1 State.” The encoder 412 can also generate “embedding SKU 2” for the “binned SKU 2 State” up to “embedding SKU N” for the “binned SKU N State.”

The decoder 414 can be configured to generate a binned action for each product given the embedding for the product. The decoder 414 can generate the binned action conditioned on any previously generated actions for products with representations that precede the representation of the product in the sequence of representations of the representation 404. Conditioning the generation of binned actions on previously generated binned actions can allow for incorporating information from previous actions that are generated. For example, the model 410 can represent how the performing of actions, such as purchasing a particular product, can affect the actions for other products.

For example, the decoder 414 can generate binned actions 430. The binned actions 430 can include a binned action for SKU 1, “binned action SKU 1,” conditioned on “embedding SKU 1.” The decoder 414 can generate a binned action for SKU 2, “binned action SKU 2,” conditioned on “embedding SKU 2” and “binned action SKU 1.” The decoder 414 can generate a binned action for SKU N, “binned action SKU N,” conditioned on “embedding SKUN,” “binned action SKU 1,” “binned action SKU 2,” and all of the binned actions generated for products up to and including SKU N−1.

Each binned action can include one or more related actions. Each binned action can be represented by a vector that represents different dimensions of a binned action. For example, a dimension can represent a product identifier for the product of the binned action, an identifier for a group of items that includes the product, or an identifier for a sales sum for the product.

The system 400 can provide each binned action to a supply chain entity. The supply chain entity may implement one or more of the binned actions 430. In some implementations, the supply chain entity can select to take one or more of the binned actions 430, and the system 400 can provide information representing the taken binned actions to the simulator. The system 400 can then receive new current state information 104 from the simulator, and generate binned actions based on the new current state information 104.

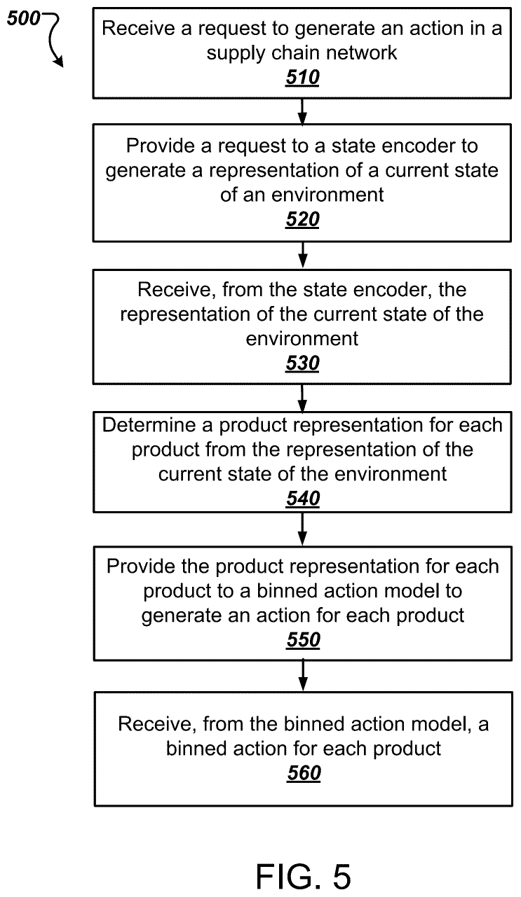

FIG. 5 is a flowchart of another process 500 for generating actions for a supply chain network. The process 500 can be performed by any appropriate system of one or more computers in one or more locations, e.g., the system 400 of FIG. 4.

The system receives a request to generate an action in a supply chain network (510). The system can generate an action in a supply chain network for a particular product based on current state information representing a current state of an environment. The environment can include one or more products, including the particular product. Current state information can include, for example, a state of the supply chain network, inventory levels for the one or more products, and shipment data for the one or more products.

The system provides a request to a state encoder to generate a representation of the current state of the environment (520). The request can include current state information. The state encoder can be configured to generate a representation of the current state of the environment given current state information. The state encoder can be the state encoder 210 described above with reference to FIG. 2, for example.

The system receives, from the state encoder, the representation of the current state of the environment (530). The representation of the current state of the environment can be a sequence of representations of products. Each representation for a product can represent information that is relevant to the product. For example, each representation for a product can include an embedding for features of the product. For example, features of a particular product can include color, shape, or size.

The system determines a product representation for each product from the representation of the current state of the environment (540). For example, the system can determine that the product representation for a product is at a particular index in the sequence of representations of products. The system can extract the product representation for each product from the representation of the current state of the environment.

The system provides the product representation for each product to a binned action model to generate a binned action for each product (550). For example, the binned action model can be configured to generate a binned action for each product given a product representation for each product. In some implementations, the binned action model can be an autoregressive model. In some of these implementations, the autoregressive model can be a Transformer model. In some implementations, the binned action model can be a diffusion model.

In some implementations, providing the product representation for each product to a binned action model can include providing the product representation for each product to an encoder that generates an embedding for each product given the product representation for the product, and providing the embedding for each product to a decoder that generates a binned action for each product. An example binned action model is described in further detail above with reference to FIG. 4.

The system receives, from the binned action model, a binned action for each product (560). The binned action can include one or more related actions.

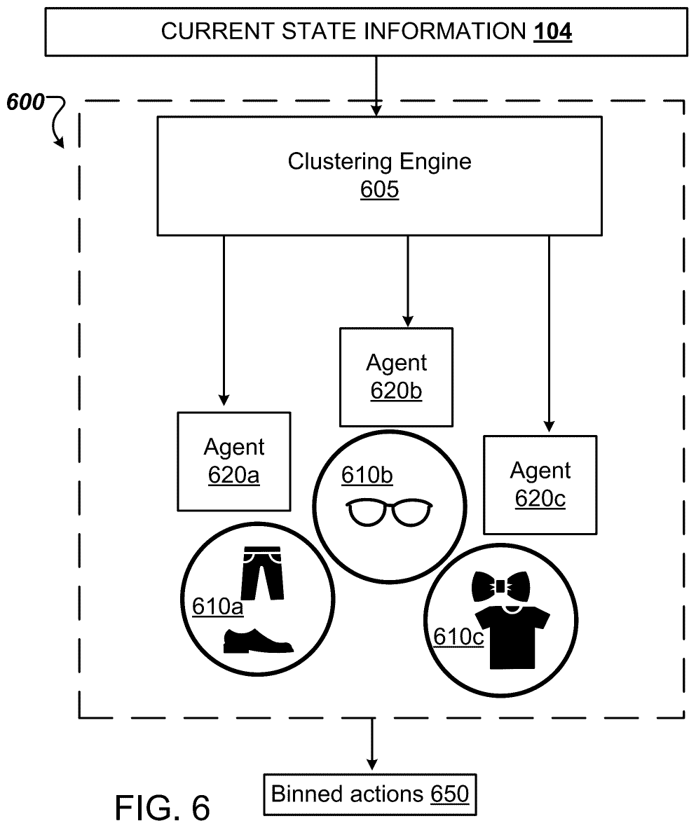

FIG. 6 is a diagram of another example system 600 for generating actions for a supply chain network. The system 600 is an example of a system implemented as computer programs on one or more computers in one or more locations in which the systems, components, and techniques described below are implemented.

The system 600 includes various components, such as a clustering engine 605 and one or more agents such as agent 620a, agent 620b, and agent 620c (collectively referred to as “agents 620”). In some implementations, the clustering engine 605 and the agents 620 can be part of a same system and/or network of computing devices and/or systems.

The system 600 can provide actions for one or more products of the supply chain network. The system 600 can receive information about the supply chain network, including information about the products of the supply chain network, and generate a binned action for each product using the agents 620. The system 600 can use agents 620 to generate a binned action for a particular product. For example, each agent of the agents 620 can use the system 100 of FIG. 1 or the system 400 of FIG. 4 described above to generate a binned action for each of the products the agent is assigned to.

The system 600 can receive current state information 104. The current state information 104 can include information representing a current state of an environment that includes multiple products. The current state information 104 is described in more detail above with reference to FIG. 1.

The system 600 can provide the current state information 104 to the clustering engine 605. The clustering engine 605 can cluster the products into one or more clusters of products such as cluster 610a, cluster 610b, and cluster 610c (collectively referred to as “clusters 610”). Each cluster can include one or more products. The clustering engine 605 can cluster the products based on similarity between each product and a cluster center. For example, each cluster 610a, 610b, and 610c can have a corresponding cluster center.

The clustering engine 605 can obtain cluster centers. For example, the cluster centers can be the centers of clusters that have been generated by a training system for the system 600. The training system can receive training data with information about products and cluster the products based on similarity between each product. For example, products in each cluster can have a higher similarity with each other than with products in other clusters. The similarity between products can be a similarity based on information in the training data about each product such as demand pattern, season, identifier, color, shape, and/or size. The training system can cluster the products using clustering techniques such as principal component analysis, dimensionality reduction, or K-means clustering, for example.

The clustering engine 605 can assign each product of the current state information 104 to the cluster of the nearest cluster center. For example, for each product, the clustering engine 605 can determine a representation of the product in the same space as the centers. The clustering engine 605 can determine the nearest cluster center to the representation of the product. The clustering engine 605 can assign the product to the cluster of the cluster center.

Each cluster can have an associated agent that is assigned to the cluster and is configured to generate binned actions for the products in the cluster. For example, the agent 620a can be assigned to the cluster 610a. The agent 620b can be assigned to the cluster 610b, and the agent 620c can be assigned to the cluster 610c. The training system can train each agent on to generate binned actions for the products in the associated cluster of the training data.

As an example, the products can be clustered by seasonality. For example, each cluster center can be associated with a certain season such as spring, summer, fall, and winter. The clustering engine 605 can assign products to the nearest cluster center. Each associated agent can have been trained to generate binned actions for the particular season of the cluster.

As another example, the products can be clustered by type. For example, each cluster center can be associated with a certain type of item. The clustering engine 605 can assign products to the nearest cluster center. Each associated agent can have been trained to generate binned actions for the type of item of the cluster.

As another example, the products can be clustered by an identifier. For example, each cluster center can be associated with certain identifiers of products, such as item codes. The clustering engine 605 can assign products with certain identifiers to the associated cluster center. Each associated agent can have been trained to generate binned actions for the products with certain identifiers of the cluster.

The agents 620 can use systems configured to generate binned actions, such as the system 100 of FIG. 1 or system 400 of FIG. 4. For example, the agent 620a can use the system 100 of FIG. 1 to generate a binned action for each product in the cluster 610a. The agent 620a can generate a binned action by providing the current state information 104 for the products in the cluster 610a to the action model 102 and sequence model 120 as described above with reference to FIG. 1. As another example, the agent 620b can use the system 400 of FIG. 4 to generate a binned action for each product in the cluster 610b. The agent 620b can generate a binned action by providing the current state information 104 for the products in the cluster 610b to the state encoder 402 and the binned action model 410 as described above with reference to FIG. 4.

In some implementations, each agent can be configured to generate binned actions in the same manner. For example, the agents 620 can be configured to use the system 100 of FIG. 1. The agents 620 can also be configured to use the system 400 of FIG. 4. In some implementations, different agents can be configured to generate binned actions in different manners. For example, the agent 620a can use the system 100 of FIG. 1, the agent 620b can use the system 400 of FIG. 4, and the agent 620c can use the system 400 of FIG. 4, or another system configured to generate binned actions.

In some implementations, each agent can be configured to select from a corresponding set of possible actions. In these implementations, each agent can generate the binned action for each product in the cluster from the set of possible actions. For example, the agents 620 can have been trained by the training system to generate actions from a set of possible actions. For example, the training system can train each agent by providing each agent with an action space that includes one or more of all the possible actions.

In some implementations, a particular agent can be assigned to more than one cluster. For example, the agent 620a can generate binned actions for products of the cluster 610a and the cluster 610b. For example, for a large number of clusters, assigning an agent to each cluster may require more computational resources to train the large number of agents. Thus, in some examples assigning an agent to more than one cluster can make the system more computationally efficient.

In some implementations, one or more of the clusters 610 can include subclusters. For example, the cluster 610a can include products associated with the winter such as ski pants and snow boots. Within the cluster 610a, the clustering engine 605 can cluster the products of the cluster 610a into subclusters. For example, the clustering engine 605 can cluster the products into a subcluster for clothing and a subcluster for footwear. Each of the subclusters can have an associated agent that is assigned to the subcluster. Each agent assigned to a subcluster can be configured to generate binned actions for each product in the subcluster.

The system can thus generate binned actions 650 that includes a binned action for each product in the current state information 104 using the clustering engine 605 and the agents 620. The system can provide the binned actions 650 to a supply chain entity. In some implementations, the supply chain entity can select to take one or more of the binned actions, and the system 600 can provide information representing the taken binned actions to the simulator. The system 600 can then receive new current state information 104 from the simulator, and generate binned actions based on the new current state information 104.

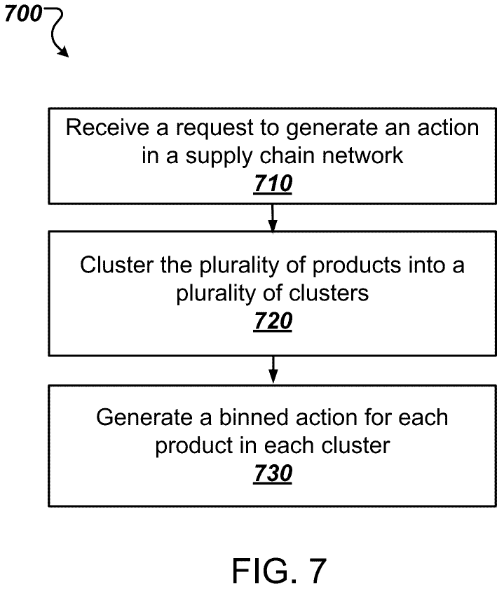

FIG. 7 is a flowchart of another process 700 for generating actions for a supply chain network. The process 700 can be performed by any appropriate system of one or more computers in one or more locations, e.g., the system 600 of FIG. 6.

The system receives a request to generate an action in a supply chain network (710). The system can generate an action in a supply chain network for a particular product based on current state information representing a current state of an environment. The environment can include one or more products, including the particular product. Current state information representing a current state of an environment can include, for example, a state of the supply chain network, inventory levels for the one or more products, and shipment data for the one or more products.

The system clusters the plurality of products into a plurality of clusters (720). The products can be clustered based on similarity between each product and one or more cluster centers. The similarity can be a similarity based on demand pattern, season, identifier, color, shape, and/or size, for example. The cluster centers can have been determined based on the products of the training data. The products can be clustered using spectral clustering methods such as principal component analysis or K-means clustering, for example.

The system generates a binned action for each product in each cluster (730). The system can generate a binned action for each product in each cluster using an agent assigned to each cluster. The binned action can include one or more related actions. Each agent can be configured to generate a binned action for each product in the cluster to which the agent is assigned.

In some implementations, a particular agent can be assigned to more than one cluster. In some implementations, one or more of the clusters can include multiple subclusters, and generating a binned action for each product in each cluster can include using an agent assigned to each subcluster.

In some implementations, each agent can be configured to select from a corresponding set of possible actions that includes one or more of the possible actions over all of the products. Each agent can receive information representing the current state of the environment for the products in the cluster. Each agent can generate the binned action for each product in the cluster from the set of possible actions.

Each agent can include a system such as the system 100 described above in FIG. 1. For example, an agent using the system 100 can perform a process similar to the process 300 described above with reference to FIG. 3 to generate a binned action for each product in the cluster. That is, the system can provide a request to an action model to generate a respective probability distribution for one or more actions in the set of possible actions for the one or more products in the cluster. The system can receive, from the action model, the respective probability distributions for the one or more products in the cluster. The system can determine, for each product, a binned action from the respective probability distribution. The system can provide a request to a sequence model to generate a respective correction for the one or more binned actions. The system can receive, from the sequence model, the respective correction for the respective binned action. The system can apply the respective correction for each respective binned action. The system can provide each corrected binned action to the agent.

As another example, each agent can include a system such as the system 400 described above in FIG. 4. For example, an agent using the system 400 can perform a process similar to the process 500 described above with reference to FIG. 5 to generate a binned action for each product in the cluster. That is, the system can provide a request to a state encoder to generate a representation of the current state of the environment for the cluster. The system can receive, from the state encoder, the representation of the current state of the environment for the cluster. The system can determine a product representation for each product in the cluster from the representation of the current state of the environment for the cluster. The system can provide the product representation for each product in the cluster to a binned action model to generate an action from the set of possible actions for each product in the cluster. The system can receive, from the binned action model, a binned action for each product in the cluster. The system can provide each binned action for each product in the cluster to the agent.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method performed by one or more computers, the method comprising:
receiving a request to generate an action in a supply chain network for a particular product based on current state information representing a current state of an environment, wherein the environment comprises one or more products;
providing a request to an action model to generate a respective probability distribution for one or more actions for the one or more products;
receiving, from the action model, the respective probability distributions for the one or more products;
determining, for each product, a binned action from the respective probability distribution, wherein the binned action comprises one or more related actions;
providing a request to a sequence model to generate a respective correction for the one or more binned actions, wherein the request comprises an input based on the respective binned action for the one or more products; and
receiving, from the sequence model, the respective correction for the respective binned action.

Embodiment 2 is the method of embodiment 1, wherein the action model comprises a state encoder that generates a representation of the current state of the environment given current state information.

Embodiment 3 is the method of any one of embodiments 1-2, wherein the action model comprises a trained reinforcement learning model that generates a probability distribution for one or more actions for the particular product given a representation of the current state of the environment and an identifier for the particular product.

Embodiment 4 is the method of any one of embodiments 2-3, wherein the representation of the current state of the environment comprises an embedding for features of each of the one or more products.

Embodiment 5 is the method of embodiment 4, wherein the features comprise any one or more of: color, shape, or size.

Embodiment 6 is the method of any one of embodiments 1-5, wherein current state information representing the current state of the environment comprises a state of the supply chain network, inventory levels for the one or more products, and shipment data for the one or more products.

Embodiment 7 is the method of any one of embodiments 1-6, wherein the method further comprises, for each binned action, applying the respective correction for the binned action.

Embodiment 8 is a method performed by one or more computers, the method comprising:
receiving a request to generate an action in a supply chain network for a particular product based on current state information representing a current state of an environment, wherein the environment comprises one or more products;
providing a request to a state encoder to generate a representation of the current state of the environment given current state information;
receiving, from the state encoder, the representation of the current state of the environment;
determining a product representation for each product from the representation of the current state of the environment;
providing the product representation for each product to a binned action model to generate a binned action for each product; and
receiving, from the binned action model, a binned action for each product, wherein the binned action comprises one or more related actions.

Embodiment 9 is the method of embodiment 8, wherein the binned action model is an autoregressive model.

Embodiment 10 is the method of embodiment 9, wherein the autoregressive model is a Transformer model.

Embodiment 11 is the method of any one of embodiments 8-10, wherein the binned action model is a diffusion model.

Embodiment 12 is the method of any one of embodiments 8-11, wherein providing the product representation for each product to the binned action model comprises:
providing the product representation for each product to an encoder that generates an embedding for each product given the product representation for the product; and
providing the embedding for each product to a decoder that generates a binned action for each product.

Embodiment 13 is the method of any one of embodiments 8-12, wherein current state information representing the current state of the environment comprises a state of the supply chain network, inventory levels for the one or more products, and shipment data for the one or more products.

Embodiment 14 is a method performed by one or more computers, the method comprising:
receiving a request to generate an action in a supply chain network for a particular product based on current state information representing a current state of an environment, wherein the environment comprises a plurality of products;
clustering the plurality of products into a plurality of clusters; and
generating a binned action for each product in each cluster using an agent assigned to each cluster, wherein the binned action comprises one or more related actions.

Embodiment 15 is the method of embodiment 14, wherein clustering the plurality of products into a plurality of clusters comprises clustering the plurality of products based on similarity between each product and one or more cluster centers, and wherein the similarity is a similarity based on any one or more of: demand pattern, season, identifier, color, shape, or size.

Embodiment 16 is the method of any one of embodiments 14-15, wherein each agent is configured to select from a corresponding set of possible actions, and wherein generating a binned action for each product in each cluster using an agent assigned to each cluster comprises, for each agent:
receiving information representing the current state of the environment for the products in the cluster; and
generating the binned action for each product in the cluster from the set of possible actions.

Embodiment 17 is the method of any one of embodiments 14-16, wherein a particular agent is assigned to more than one cluster.

Embodiment 18 is the method of any one of embodiments 14-17, wherein one or more clusters comprise a plurality of subclusters, and wherein generating a binned action for each product in each cluster comprises using an agent assigned to each subcluster.

Embodiment 19 is the method of any one of embodiments 16-18, wherein generating the binned action for each product in the cluster comprises:
providing a request to an action model to generate a respective probability distribution for one or more actions in the set of possible actions for the one or more products in the cluster;
receiving, from the action model, the respective probability distributions for the one or more products in the cluster;
determining, for each product, a binned action from the respective probability distribution, wherein the binned action comprises one or more related actions;
providing a request to a sequence model to generate a respective correction for the one or more binned actions, wherein the request comprises an input based on the respective binned action for the one or more products; and
receiving, from the sequence model, the respective correction for the respective binned action.

Embodiment 20 is the method of embodiment 19, wherein the action model comprises a state encoder that generates a representation of the current state of the environment given current state information.

Embodiment 21 is the method of any one of embodiments 19-20, wherein the action model comprises a trained reinforcement learning model that generates a probability distribution for one or more actions in the set of possible binned actions for the particular product given a representation of the current state of the environment and an identifier for the particular product.

Embodiment 22 is the method of any one of embodiments 20-21, wherein the representation of the current state of the environment comprises an embedding for features of each of the one or more products.

Embodiment 23 is the method of embodiment 22, wherein the features comprise any one or more of: color, shape, or size.

Embodiment 24 is the method of any one of embodiments 19-23, wherein current state information representing the current state of the environment comprises a state of the supply chain network, inventory levels for the one or more products, and shipment data for the one or more products.

Embodiment 25 is the method of any one of embodiments 19-24, further comprising, for each binned action, applying the respective correction for the binned action.

Embodiment 26 is the method of any one of embodiments 16-18, wherein generating the action for each product in the cluster comprises:
providing a request to a state encoder to generate a representation of the current state of the environment for the cluster given current state information;
receiving, from the state encoder, the representation of the current state of the environment for the cluster;
determining a product representation for each product in the cluster from the representation of the current state of the environment for the cluster;
providing the product representation for each product in the cluster to a binned action model to generate an action from the set of possible actions for each product in the cluster; and
receiving, from the binned action model, a binned action for each product in the cluster.

Embodiment 27 is the method of embodiment 26, wherein the binned action model is an autoregressive model.

Embodiment 28 is the method of embodiment 27, wherein the autoregressive model is a Transformer model.

Embodiment 29 is the method of any one of embodiments 26-28, wherein the binned action model is a diffusion model.

Embodiment 30 is the method of any one of embodiments 26-29, wherein providing the product representation for each product to the binned action model comprises:
providing the product representation for each product to an encoder that generates an embedding for each product given the product representation for the product; and
providing the embedding for each product to a decoder that generates a binned action for each product.

Embodiment 31 is the method of any one of embodiments 26-30, wherein current state information representing the current state of the environment comprises a state of the supply chain network, inventory levels for the one or more products, and shipment data for the one or more products.

Embodiment 32 is a system comprising:
one or more computers; and
one or more storage devices storing instructions that are operable, when executed by the one or more computers, to cause the one or more computers to perform operations comprising:
   receiving a request to generate an action in a supply chain network for a particular product based on current state information representing a current state of an environment, wherein the environment comprises one or more products;
      providing a request to an action model to generate a respective probability distribution for one or more actions for the one or more products;
      receiving, from the action model, the respective probability distributions for the one or more products;
      determining, for each product, a binned action from the respective probability distribution, wherein the binned action comprises one or more related actions;
      providing a request to a sequence model to generate a respective correction for the one or more binned actions, wherein the request comprises an input based on the respective binned action for the one or more products; and
      receiving, from the sequence model, the respective correction for the respective binned action.

Embodiment 33 is a computer storage medium encoded with a computer program, the program comprising instructions that are operable, when executed by data processing apparatus, to cause the data processing apparatus to perform operations comprising:
receiving a request to generate an action in a supply chain network for a particular product based on current state information representing a current state of an environment, wherein the environment comprises one or more products;
   providing a request to an action model to generate a respective probability distribution for one or more actions for the one or more products;
   receiving, from the action model, the respective probability distributions for the one or more products;
   determining, for each product, a binned action from the respective probability distribution, wherein the binned action comprises one or more related actions;
   providing a request to a sequence model to generate a respective correction for the one or more binned actions, wherein the request comprises an input based on the respective binned action for the one or more products; and
   receiving, from the sequence model, the respective correction for the respective binned action.

Embodiment 34 is a system comprising: one or more computers and one or more storage devices storing instructions that are operable, when executed by the one or more computers, to cause the one or more computers to perform the method of any one of embodiments 1 to 7.

Embodiment 35 is a computer storage medium encoded with a computer program, the program comprising instructions that are operable, when executed by data processing apparatus, to cause the data processing apparatus to perform the method of any one of embodiments 1 to 7.

Embodiment 36 is a system comprising:
one or more computers; and
one or more storage devices storing instructions that are operable, when executed by the one or more computers, to cause the one or more computers to perform operations comprising:
   receiving a request to generate an action in a supply chain network for a particular product based on current state information representing a current state of an environment, wherein the environment comprises one or more products;
   providing a request to a state encoder to generate a representation of the current state of the environment given current state information;
      receiving, from the state encoder, the representation of the current state of the environment;
      determining a product representation for each product from the representation of the current state of the environment;
   providing the product representation for each product to a binned action model to generate a binned action for each product; and
      receiving, from the binned action model, a binned action for each product, wherein the binned action comprises one or more related actions.

Embodiment 37 is a computer storage medium encoded with a computer program, the program comprising instructions that are operable, when executed by data processing apparatus, to cause the data processing apparatus to perform operations comprising:
receiving a request to generate an action in a supply chain network for a particular product based on current state information representing a current state of an environment, wherein the environment comprises one or more products;
providing a request to a state encoder to generate a representation of the current state of the environment given current state information;
   receiving, from the state encoder, the representation of the current state of the environment;
   determining a product representation for each product from the representation of the current state of the environment;
providing the product representation for each product to a binned action model to generate a binned action for each product; and
   receiving, from the binned action model, a binned action for each product, wherein the binned action comprises one or more related actions.

Embodiment 38 is a system comprising: one or more computers and one or more storage devices storing instructions that are operable, when executed by the one or more computers, to cause the one or more computers to perform the method of any one of embodiments 8 to 13.

Embodiment 39 is a computer storage medium encoded with a computer program, the program comprising instructions that are operable, when executed by data processing apparatus, to cause the data processing apparatus to perform the method of any one of embodiments 8 to 13.

Embodiment 40 is a system comprising:
one or more computers; and
one or more storage devices storing instructions that are operable, when executed by the one or more computers, to cause the one or more computers to perform operations comprising:
   receiving a request to generate an action in a supply chain network for a particular product based on current state information representing a current state of an environment, wherein the environment comprises a plurality of products;
   clustering the plurality of products into a plurality of clusters; and
      generating a binned action for each product in each cluster using an agent assigned to each cluster, wherein the binned action comprises one or more related actions.

Embodiment 41 is a computer storage medium encoded with a computer program, the program comprising instructions that are operable, when executed by data processing apparatus, to cause the data processing apparatus to perform operations comprising:
receiving a request to generate an action in a supply chain network for a particular product based on current state information representing a current state of an environment, wherein the environment comprises a plurality of products;
clustering the plurality of products into a plurality of clusters; and
   generating a binned action for each product in each cluster using an agent assigned to each cluster, wherein the binned action comprises one or more related actions.

Embodiment 42 is a system comprising: one or more computers and one or more storage devices storing instructions that are operable, when executed by the one or more computers, to cause the one or more computers to perform the method of any one of embodiments 14 to 31.

Embodiment 43 is a computer storage medium encoded with a computer program, the program comprising instructions that are operable, when executed by data processing apparatus, to cause the data processing apparatus to perform the method of any one of embodiments 14 to 31.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
receiving a request to generate an action in a supply chain network for a particular product based on current state information representing a current state of an environment, wherein the environment comprises one or more products;
providing a request to an action model to generate a respective probability distribution for one or more actions for the one or more products;
receiving, from the action model, the respective probability distributions for the one or more products;
determining, for each product, a binned action from the respective probability distribution, wherein the binned action comprises one or more related actions;
providing a request to a sequence model to generate a respective correction for the one or more binned actions, wherein the request comprises an input based on the respective binned action for the one or more products; and
receiving, from the sequence model, the respective correction for the respective binned action.

2. The method of claim 1, wherein the action model comprises a state encoder that generates a representation of the current state of the environment given current state information.

3. The method of claim 1, wherein the action model comprises a trained reinforcement learning model that generates a probability distribution for one or more actions for the particular product given a representation of the current state of the environment and an identifier for the particular product.

4. The method of claim 2, wherein the representation of the current state of the environment comprises an embedding for features of each of the one or more products.

5. The method of claim 4, wherein the features comprise any one or more of: color, shape, or size.

6. The method of claim 1, wherein current state information representing the current state of the environment comprises a state of the supply chain network, inventory levels for the one or more products, and shipment data for the one or more products.

7. The method of claim 1, further comprising, for each binned action, applying the respective correction for the binned action.

8. A method performed by one or more computers, the method comprising:
receiving a request to generate an action in a supply chain network for a particular product based on current state information representing a current state of an environment, wherein the environment comprises one or more products;
providing a request to a state encoder to generate a representation of the current state of the environment given current state information;
receiving, from the state encoder, the representation of the current state of the environment;
determining a product representation for each product from the representation of the current state of the environment;
providing the product representation for each product to a binned action model to generate a binned action for each product; and
receiving, from the binned action model, a binned action for each product, wherein the binned action comprises one or more related actions.

9. The method of claim 8, wherein the binned action model is an autoregressive model.

10. The method of claim 9, wherein the autoregressive model is a Transformer model.

11. The method of claim 8, wherein the binned action model is a diffusion model.

12. The method of claim 8, wherein providing the product representation for each product to the binned action model comprises:
providing the product representation for each product to an encoder that generates an embedding for each product given the product representation for the product; and
providing the embedding for each product to a decoder that generates a binned action for each product.

13. The method of claim 8, wherein current state information representing the current state of the environment comprises a state of the supply chain network, inventory levels for the one or more products, and shipment data for the one or more products.

14. A method performed by one or more computers, the method comprising:
receiving a request to generate an action in a supply chain network for a particular product based on current state information representing a current state of an environment, wherein the environment comprises a plurality of products;
clustering the plurality of products into a plurality of clusters; and
generating a binned action for each product in each cluster using an agent assigned to each cluster, wherein the binned action comprises one or more related actions.

15. The method of claim 14, wherein clustering the plurality of products into a plurality of clusters comprises clustering the plurality of products based on similarity between each product and one or more cluster centers, and wherein the similarity is a similarity based on any one or more of: demand pattern, season, identifier, color, shape, or size.

16. The method of claim 14, wherein each agent is configured to select from a corresponding set of possible actions, and wherein generating a binned action for each product in each cluster using an agent assigned to each cluster comprises, for each agent:
receiving information representing the current state of the environment for the products in the cluster; and
generating the binned action for each product in the cluster from the set of possible actions.

17. The method of claim 14, wherein a particular agent is assigned to more than one cluster.

18. The method of claim 14, wherein one or more clusters comprise a plurality of subclusters, and wherein generating a binned action for each product in each cluster comprises using an agent assigned to each subcluster.

19. The method of claim 16, wherein generating the binned action for each product in the cluster comprises:
providing a request to an action model to generate a respective probability distribution for one or more actions in the set of possible actions for the one or more products in the cluster;
receiving, from the action model, the respective probability distributions for the one or more products in the cluster;
determining, for each product, a binned action from the respective probability distribution, wherein the binned action comprises one or more related actions;
providing a request to a sequence model to generate a respective correction for the one or more binned actions, wherein the request comprises an input based on the respective binned action for the one or more products; and
receiving, from the sequence model, the respective correction for the respective binned action.

20. The method of claim 19, wherein the action model comprises a state encoder that generates a representation of the current state of the environment given current state information.

21. The method of claim 19, wherein the action model comprises a trained reinforcement learning model that generates a probability distribution for one or more actions in the set of possible binned actions for the particular product given a representation of the current state of the environment and an identifier for the particular product.

22. The method of claim 20, wherein the representation of the current state of the environment comprises an embedding for features of each of the one or more products.

23. The method of claim 22, wherein the features comprise any one or more of: color, shape, or size.

24. The method of claim 19, wherein current state information representing the current state of the environment comprises a state of the supply chain network, inventory levels for the one or more products, and shipment data for the one or more products.

25. The method of claim 19, further comprising, for each binned action, applying the respective correction for the binned action.

26. The method of claim 16, wherein generating the action for each product in the cluster comprises:
providing a request to a state encoder to generate a representation of the current state of the environment for the cluster given current state information;
receiving, from the state encoder, the representation of the current state of the environment for the cluster;
determining a product representation for each product in the cluster from the representation of the current state of the environment for the cluster;
providing the product representation for each product in the cluster to a binned action model to generate an action from the set of possible actions for each product in the cluster; and
receiving, from the binned action model, a binned action for each product in the cluster.

27. The method of claim 26, wherein the binned action model is an autoregressive model.

28. The method of claim 27, wherein the autoregressive model is a Transformer model.

29. The method of claim 26, wherein the binned action model is a diffusion model.

30. The method of claim 26, wherein providing the product representation for each product to the binned action model comprises:
providing the product representation for each product to an encoder that generates an embedding for each product given the product representation for the product; and
providing the embedding for each product to a decoder that generates a binned action for each product.

31. The method of claim 26, wherein current state information representing the current state of the environment comprises a state of the supply chain network, inventory levels for the one or more products, and shipment data for the one or more products.
